(19) United States
(12) Patent Application Publication
(10) Pub. No.: US 2018/0186926 A1
(43) Pub. Date: Jul. 5, 2018

(54) POLYESTER RESIN POWDER MIXTURE

(71) Applicant: Toray Industries, Inc., Tokyo (JP)

(72) Inventors: Kei Watanabe, Tokai (JP); Kazusada Takeda, Tokai (JP); Yosuke Nishimura, Nagoya (JP); Hiroshi Takezaki, Nagoya (JP); Hisashi Miyama, Tokyo (JP); Mikiya Nishida, Tokyo (JP)

(21) Appl. No.: 15/740,141

(22) PCT Filed: Apr. 27, 2016
(86) PCT No.: PCT/JP2016/063241

§ 371 Date: Dec. 27, 2017

(30) Foreign Application Priority Data
Jun. 29, 2015 (JP) 2015-129966

(51) Int. Cl. C08G 63/183; C08K 3/36; C08K 3/40; C08K 3/30; C08K 3/22; C08K 3/04; C08J 3/20

(52) U.S. Cl. CPC C08G 63/183; C08K 3/36; C08K 3/40; C08K 3/30; C08K 3/22; C08K 2201/003; C08J 3/203; C08K 2003/2227; C08K 2003/2296; C08K 2003/3045; C08K 3/04

(57) ABSTRACT

A polyester resin powder mixture has a small average particle size, excellent powder flowability, and high strength after molding. The polyester resin powder mixture is obtained by blending 0.1-5 parts by weight of silica microparticles having an average particle size of 20-500 nm in 100 parts by weight of a polyester resin powder having an average particle size that is over 1 μm and is less than or equal to 100 μm, and that has a uniformity of 4 or less.

### TECHNICAL FIELD

This disclosure relates to a polyester resin powder mixture having a small mean diameter, high powder flowability, and a low compressibility.

### BACKGROUND

Polyesters such as polybutylene terephthalate (hereinafter occasionally abbreviated as PBT) have properties suitable as engineering plastics including excellent heat resistance, barrier property, chemical resistance, electrical insulation, and moist heat resistance, and have been used in various electric/electronic parts, machine parts, automobile parts, films, fibers, and the like that are produced mainly by injection molding or extrusion molding.

Having such excellent properties, polyester resin particulate products are much in demand as materials for various moldings, printer toners, coatings, heat resistant additives and the like, and some techniques such as described below, have been proposed for producing polyester resin particulate products.

Japanese Unexamined Patent Publication (Kokai) No. SHO 63-248875 describes a method in which saturated polyester resin pellets are heated and dissolved in dimethyl acetamide or dimethyl formamide and gradually cooled to obtain powder material.

Japanese Unexamined Patent Publication (Kokai) No. 2012-197461 discloses a method in which an emulsion consisting mainly of two separated phases that contain different polymers as main components is formed and then a poor solvent for either of the polymers is brought into contact with the emulsion to precipitate that polymer, thereby providing fine polymer particles.

To improve the fluidity of resin powder material, Japanese Unexamined Patent Publication (Kokai) No. 2013-166667 proposes a method in which inorganic particles are added to increase the distances among particles to relax the interaction among the particles.

However, when a polyester resin powder material produced by the method described in Japanese Unexamined Patent Publication (Kokai) No. SHO 63-248875 or Japanese Unexamined Patent Publication (Kokai) No. 2012-197461 is used for molding, its excellent electrical insulating properties will lead to a low flowability as a result of its coagulation which will be easily caused by static electricity, resulting in frequent troubles in supply and discharge in silos and the like during the production process. In addition, polyester resin powder materials are high in compressibility and suffer from an increase in bulkiness and a further decrease in flowability at the bottoms of the silo, hopper or the like, as a result of compression caused by powder pressure.

It could therefore be helpful to provide an efficient production of a polyester resin powder material that is small in mean diameter, high in powder flowability, and low in compressibility and forms high strength moldings.

### SUMMARY

We thus provide:
(1) A polyester resin powder mixture including a polyester resin powder material having a mean diameter of more than 1 μm and 100 μm or less and a uniformity coefficient of 4 or less and inorganic particles having a mean diameter of 20 to 500 nm, the inorganic particles accounting for 0.1 to 5 parts by weight relative to 100 parts by weight of the polyester resin powder material.
(2) A polyester resin powder mixture as set forth in paragraph (1), wherein the polyester is polybutylene terephthalate.
(3) A polyester resin powder mixture as set forth in either paragraph (1) or (2), wherein the inorganic particles are silica particles.
(4) A polyester resin powder mixture as set forth in any one of paragraphs (1) to (3) further including an inorganic reinforcement material having an average maximum size of 1 μm or more and 200 μm or less and accounting for 25 to 150 parts by weight relative to 100 parts by weight of the polyester resin powder material.
(5) A polyester resin powder mixture as set forth in paragraph (4), wherein the inorganic reinforcement material is at least one selected from the group consisting of glass beads, glass flakes, glass fiber, carbon fiber, aluminum oxide, soda lime glass, borosilicate glass, silica, aluminosilicate ceramics, limestone, gypsum, bentonite, precipitated sodium silicate, amorphous precipitated silica, amorphous precipitated calcium silicate, amorphous precipitated magnesium silicate, amorphous precipitated lithium silicate, sodium chloride, Portland cement, magnesium phosphate cement, magnesium oxychloride cement, magnesium oxysulfate cement, zinc phosphate cement, and zinc oxide.

We thus efficiently produce a polyester resin powder mixture that is small in mean diameter, high in powder flowability, low in compressibility, and useful to provide high strength moldings.

### DETAILED DESCRIPTION

### Polyester Resin

A suitable polyester resin can be produced through condensation polymerization of either a polybasic acid or a polybasic acid dialkyl ester and a polyhydric alcohol as main materials. Being the main materials means that the constituent units formed from the polybasic acid or the polybasic acid dialkyl ester and the polyhydric alcohol will account for 25 wt % or more of the resulting polymer. The constituent units formed from the polybasic acid or the polybasic acid dialkyl ester and the polyhydric alcohol preferably account for 40 wt % or more, more preferably 50 wt % or more. There are no specific limitations on the polyhydric alcohol, and examples include ethylene glycol, diethylene glycol, triethylene glycol, 1,2-propylene glycol, other propylene glycols, dipropylene glycols, 1,4-butanediol, other butanediols, neopentyl glycol, 1,6-hexanediol, other alkylene glycols (aliphatic glycols), alkylene oxide adducts thereof, bisphenol A, hydrogenated bisphenol, other bisphenols, phenolic glycols of these alkylene oxide adducts, alicyclic and aromatic diols (including monocyclic and polycyclic ones), glycerin, trimethylolpropane, and other triols. They may be used singly or as a mixture of a plurality thereof.

Examples of the polybasic acid (polycarboxylic acid) include saturated or unsaturated (or aromatic) polybasic acids such as malonic acid, succinic acid, adipic acid, azelaic acid, sebacic acid, fumaric acid, maleic acid, itaconate, phthalic acid, modified acids thereof (for example, hexahydrophthalic anhydrides), isophthalic acid, terephthalic acid, trimellitic acid, trimesic acid, and pyromellitic acid, as well as anhydrides thereof and lower alkyl esters thereof, and may be used singly or as a mixture of a plurality thereof.

Of these polyester resins, PBT resins are particularly preferred. A PBT resin is a resin in which PBTs account for 80 wt % or more, preferably 85 wt % or more, and it may be copolymerized or mixed with another resin that is not a PBT resin. A PBT is a polyester containing a butylene terephthalate component as main repeating unit. The main repeating unit as referred to here is one that accounts for 80 mol % or more, preferably 85 mol % or more, of the total repeating units. Other acid components include aromatic dicarboxylic acids such as isophthalic acid, orthophthalic acid, naphthalene dicarboxylic acid, diphenyl dicarboxylic acid, and sodium sulfoisophthalic acid; alicyclic dicarboxylic acids such as cyclohexanedicarboxylic acid and deca phosphorus dicarboxylic acid; and aliphatic dicarboxylic acids such as oxalic acid, malonic acid, succinic acid, sebacic acid, adipic acid, and dodecanedioic acid; whereas specific examples of such other diol components that may be used partially include aliphatic diols such as ethylene glycol, diethylene glycol, triethylene glycol, polyethylene glycol, propylene glycol, neopentyl glycol, 1,6-hexanediol, polypropylene glycol, and polytetramethylene glycol; alicyclic diols such as 1,4-cyclohexanediol and 1,4-cyclohexanedimethanol; and aromatic diols such as 2,2-bis(4′-hydroxyphenyl) propane. Each of these copolymerization components preferably accounts for 40 mol % or less relative to the terephthalic acid or 1,4-butanediol.

The polyester resins preferably have a weight average molecular weight of 1,000 to 1,000,000. The lower limit of weight average molecular weight is preferably 1,000, more preferably 5,000, and still more preferably 10,000. The upper limit of weight average molecular weight is preferably 1,000,000, more preferably 500,000, particularly preferably 100,000, and most preferably 50,000.

A high strength will not be achieved during the molding process if the weight average molecular weight of the polyester resin is less than 1,000, whereas the melt viscosity will increase to make molding difficult if it is more than 1,000,000.

The weight average molecular weight as referred to herein means a weight average molecular weight measured by gel permeation chromatography (GPC) using 1,1,1,3,3,3-hexafluoro-2-propanol as solvent and converted in terms of polystyrene.

Furthermore, the difference between the crystallization temperature and the melting point of the polyester resin is preferably 30° C. or more. The melting point and the crystallization temperature mean the temperature at the endothermic peak attributed to melting and that at the exothermic peak attributed to crystallization determined during a differential scanning calorimetry (DSC) process in which the polymer is heated once over a temperature range of 30° C. to a temperature 30° C. above its melting point at a heating rate of 20° C./min, maintained there for one minute, and then cooled to 0° C. at a rate of 20° C./min. Film breakage or cracking may be caused during film production from melts if the difference between the crystallization temperature and the melting point of the polyester resin is less than 30° C.

### Polyester Resin Powder Material

A polyester resin powder material having a mean diameter of more than 1 μm and 100 μm or less is used. The lower limit of the mean diameter of the polyester resin powder material is preferably 3 μm, more preferably 5 μm, still more preferably 8 μm, particularly preferably 10 μm, extremely preferably 13 μm, and most preferably 15 μm. The upper limit of the mean diameter is preferably 95 μm, more preferably 90 μm, still more preferably 85 μm, particularly preferably 80 μm, extremely preferably 75 μm, and most preferably 70 μm.

In addition, the polyester resin powder material preferably has a uniform particle size distribution. A polyester resin powder material having a smaller uniformity coefficient shows a lower compressibility under powder pressure, and the polyester resin should have a uniformity coefficient of 4 or less. The polyester resin powder material preferably has a uniformity coefficient of 3.2 or less, more preferably 3.0 or less, still more preferably 2.8 or less, particularly preferably 2.5 or less, and extremely preferably 2 or less. The lower limit of the uniformity coefficient is theoretically 1, but practically, it is preferably 1.1 or more, more preferably 1.15 or more, still more preferably 1.2 or more, particularly preferably 1.3 or more, and extremely preferably 1.4 or more. If the polyester resin powder material has a uniformity coefficient of more than 4, the compressibility will be too large to realize the advantageous effects even if the mean diameter is within the appropriate range.

The mean diameter of a polyester resin powder material means the d50 particle diameter corresponding to 50% accumulation counted from the smaller end of the particle diameter distribution curve measured by a laser diffraction type particle size analyzer according to Mie scattering/diffraction theory.

Furthermore, the uniformity coefficient of a polyester resin powder material is calculated by dividing the d60 particle diameter corresponding to 60% accumulation counted from the smaller end of the particle diameter distribution curve measured as above, by the d10 particle diameter corresponding to 10% accumulation counted from the smaller end.

### Inorganic Particles

It is important to add inorganic particles to further improve flowability of the polyester resin powder material. Flowability of the polyester resin powder material deteriorates due to interactions with particles in the neighborhood as the particle diameter decreases, but the addition of inorganic particles smaller in particle diameter than the polyester resin powder material acts to increase the interparticle distances, thereby improving the flowability.

The inorganic particles to be added to the polyester resin powder material should have a mean diameter of 20 nm or more and 500 nm or less. The mean diameter referred to here is measured by the same method as used to determine the mean diameter of the polyester resin powder material.

The upper limit of the mean diameter of the inorganic particles is preferably 400 nm, more preferably 300 nm, still more preferably 200 nm, particularly preferably 150 nm, and extremely preferably 100 nm. The lower limit is preferably 20 nm, more preferably 30 nm, still more preferably 40 nm, and particularly preferably 50 nm. If the inorganic particles have a mean diameter of more than 500 nm, they will fail to have a sufficiently large effect in improving the flowability of the polyester resin powder mixture. If the mean diameter of the inorganic particles is less than 20 nm, on the other hand, they will fail to serve for decreasing the compressibility of the polyester resin powder mixture although they can show a flowability improving effect.

When added, inorganic particles of any material may serve effectively as long as they have a mean diameter in the ranges given above, but preferred materials include: calcium carbonate powder materials such as precipitated calcium carbonate, heavy calcium carbonate, fine powdered calcium carbonate, and special calcium based fillers; clay (aluminum silicate powder) materials such as nepheline-syenite fine powder, calcined clay of montmorillonite, bentonite or the like, and silane-modified clay; talc; different types of silica (silicon dioxide) powder such as fused silica, crystal silica, and amorphous silica; silicic acid-containing compounds such as diatomaceous earth and silica sand; crushed natural mineral materials such as pumice powder, pumice balloons, slate powder, and mica powder; alumina-containing compounds such as alumina (aluminum oxide), alumina colloid (alumina sol), alumina white, and aluminum sulfate; mineral materials such as barium sulfate, lithopone, calcium sulfate, molybdenum disulfide, and graphite (black lead); glass based fillers such as glass fiber, glass beads, glass flakes, and foamed glass beads; and others such as spherical fly ash particles, volcanic glass hollow particles, synthesize inorganic hollow particles, single-crystalline potassium titanate, carbon fiber, carbon nanotube, carbon hollow spherical particles, carbon 64 fullerene, anthracite powder, artificial cryolite (cryolite), titanium oxide, magnesium oxide, basic magnesium carbonate, dolomite, potassium titanate, calcium sulfite, mica, asbestos, calcium silicate, aluminum powder, molybdenum sulfide, boron fiber, and silicon carbide fiber; of which more preferable are calcium carbonate powder, silica powder, alumina-containing compounds, and glass-based fillers. Particularly preferable are various types of silica powder and among others, amorphous silica powder is extremely preferable from the industrial point of view because it is little harmful to human bodies.

There are no specific limitations on the shape of these inorganic particles, and they may be spherical, porous, hollow, or irregular, of which spherical shapes are preferable from the viewpoint of high flowability.

The spherical shapes include not only perfect spheres, but also deformed spheres. The shape of an inorganic fine particle is evaluated on the basis of the circularity of the particle projected onto a two-dimensional plane. The circularity referred to above is calculated by dividing the circumference of a circle having the same area as the projected particle image by the circumference of the projected particle. The average circularity of such inorganic particles is preferably 0.7 or more and 1 or less, 0.8 or more and 1 or less, and still more preferably 0.9 or more and 1 or less.

Different silica powder materials are roughly divided by the production method into fumed silica produced by combustion of a silane compound, deflagrated silica produced by explosive combustion of metal silicon powder, wet silica produced by neutralization of sodium silicate and a mineral acid (including precipitated silica produced by synthesis and coagulation under alkaline conditions and gelled silica produced by synthesis and coagulation under acidic conditions), colloidal silica (silica sol) produced by synthesis of an acidic silicic acid from sodium silicate through sodium removal with ion exchange resin, followed by its polymerization under alkaline conditions, and sol-gel silica produced by hydrolysis of a silane compound, of which sol-gel silica is preferred to realize the advantageous effect.

Thus, the use of inorganic particles of silica is preferable, and the use of sol-gel silica and/or spherical silica is more preferable. Among others, the use of sol-gel spherical silica is most preferable.

It is still more preferable to use particles that are surface-hydrophobized with a silane compound, silazane compound or the like. Such surface hydrophobization serves to depress the coagulation of the inorganic particles and enhance the dispersion of the inorganic particles into the polyester resin powder material. Such silane compounds as described above include, for example, non-substituted or halogen-substituted trialkoxysilanes such as methyl trimethoxysilane, methyl triethoxysilane, ethyl trimethoxysilane, ethyl triethoxysilane, n-propyl trimethoxysilane, n-propyl triethoxysilane, isopropyl trimethoxysilane, isopropyl triethoxysilane, butyl trimethoxysilane, butyl triethoxysilane, hexyl trimethoxysilane, trifluoropropyl trimethoxysilane, and heptadecafluorodecyl trimethoxysilane, of which preferable are methyl trimethoxysilane, methyl triethoxysilane, ethyl trimethoxysilane and ethyl triethoxysilane preferably, of which more preferable are methyl trimethoxysilane, methyl triethoxysilane, and partial hydrolysis condensation products thereof. Such silazane compounds as described above include, for example, hexamethyl disilazane and hexaethyl disilazane, of which hexamethyl disilazane is more preferable. Useful monofunctional silane compounds include, for example, monosilanol compounds such as trimethyl silanol and triethyl silanol; monochlorosilanes such as trimethyl chlorosilane and triethyl chlorosilane; monoalkoxysilanes such as trimethyl methoxysilane and trimethyl ethoxysilane; monoaminosilanes such as trimethylsilyl dimethylamine and trimethylsilyl diethylamine; and monoacyl oxysilanes such as trimethyl acetoxy silane; of which preferable are trimethyl silanol, trimethyl methoxysilane, and trimethylsilyl diethylamine, of which particularly preferable are trimethyl silanol and trimethyl methoxysilane.

These inorganic particles may be used singly or as a combination of two or more thereof.

The inorganic particles blended should account for 0.1 part by weight or more and 5 parts by weight or less relative to 100 parts by weight of the polyester resin powder material. The upper limit of the blending quantity is preferably 4 parts by weight, more preferably 3 parts by weight, still more preferably 2 parts by weight, and particularly preferably 1 part by weight.

The lower limit of the blending quantity is preferably 0.2 part by weight, more preferably 0.3 part by weight, and still more preferably 0.4 part by weight.

If the blending quantity of the inorganic particles is more than 5 parts by weight, they will fail to have a sufficiently large effect in decreasing the compressibility of the polyester resin powder mixture. They will not serve effectively to improve flowability. If the blending quantity of the inorganic particles is less than 0.1 part by weight, on the other hand, they will not serve effectively to improve the flowability.

### Inorganic Reinforcement Material

An inorganic reinforcement material may be added with the aim of providing a molded polyester resin powder material having increased strength.

Such an inorganic reinforcement material to be added to a polyester resin powder material preferably has an average maximum size of 1 μm or more and 200 μm or less. The upper limit of the average maximum size of the inorganic reinforcement material is preferably 200 μm, more preferably 180 μm, still more preferably 170 μm, particularly preferably 160 μm, and extremely preferably 150 μm. The lower limit is preferably 1 μm, more preferably 5 μm, still more preferably 10 μm, and particularly preferably 15 μm. If the average maximum size of the inorganic reinforcement material is 200 μm or less, the polyester resin powder mixture will not suffer from a deterioration in flowability, whereas if the average maximum size of the inorganic reinforcement material is 1 μm or more, a sufficiently large increase in strength will be achieved when molding the polyester resin powder mixture.

In a fibrous inorganic reinforcement material, the maximum size means the fiber length and the average maximum size means the average fiber length. In addition, it is preferable for the fiber diameter to be 0.1 μm or more and 50 μm or less. The lower limit of the fiber diameter is preferably 0.1 μm, more preferably 0.5 μm, and particularly preferably 1 μm. On the other hand, the upper limit of the fiber diameter is preferably 50 μm, more preferably 40 μm, and particularly preferably 30 μm. The fiber length and the fiber diameter are determined by observing a specimen by electron microscopy at a magnification of 1,000 times, randomly selecting 100 pieces of fiber in the image, and averaging their length measurements.

In a nonfibrous inorganic reinforcement material, the mean diameter is taken as the average maximum size. The mean diameter is measured by the same method as used for the polyester powder material.

Inorganic reinforcement materials of any substance may serve effectively as long as they have an average maximum particle diameter in the ranges given above, but preferred ones include: calcium carbonate powder materials such as precipitated calcium carbonate, heavy calcium carbonate, fine powdered calcium carbonate, and special calcium based fillers; clay (aluminum silicate powder) materials such as nepheline-syenite fine powder, calcined clay of montmorillonite, bentonite or the like, and silane-modified clay; talc; different types of silica (silicon dioxide) powder such as fused silica, crystal silica, and amorphous silica; silicic acid-containing compounds such as diatomaceous earth and silica sand; crushed natural mineral materials such as pumice powder, pumice balloons, slate powder, and mica powder; alumina-containing compounds such as alumina (aluminum oxide), alumina colloid (alumina sol), alumina white, and aluminum sulfate; mineral materials such as barium sulfate, lithopone, calcium sulfate, molybdenum disulfide, and graphite (black lead); glass based fillers such as glass fiber, glass beads, glass flakes, foamed glass beads; and others such as spherical fly ash particles, volcanic glass hollow particles, synthesize inorganic hollow particles, single-crystalline potassium titanate, carbon fiber, carbon nanotube, carbon hollow particles, carbon 64 fullerene, anthracite powder, artificial cryolite (cryolite), titanium oxide, magnesium oxide, basic magnesium carbonate, dolomite, potassium titanate, calcium sulfite, mica, asbestos, calcium silicate, aluminum powder, molybdenum sulfide, boron fiber, and silicon carbide fiber; of which more preferable are glass-based fillers and carbon fiber. These inorganic reinforcement materials may be used singly or as a combination of two or more thereof.

### Production Method for Polyester Resin Powder Mixture

A suitable powder material can be obtained by preparing polyester resin particles with a large mean diameter or polyester resin particles with a large uniformity coefficient (i.e., that are not uniform) to be used as raw material and processing them by an appropriate technique such as the spray drying method in which the raw material is crushed and dissolved in a solvent and then spray-dried, the poor solvent precipitation method in which an emulsion is formed in a solvent and then brought into contact with a poor solvent, the submerged drying method in which an emulsion is formed in a solvent, followed by drying and removing the organic solvent, and the forced melt-kneading method in which the resin component to be processed into particles is mechanically kneaded together with another resin component to form a sea-island structure, followed by removing the sea component using a solvent.

The adoption of crushing is preferred from the viewpoint of economic efficiency, but there are no specific limitations on the method to be used for crushing, and examples include the use of a jet mill, bead mill, hammer mill, ball mill, sand mill, turbo mill, and freeze crusher. Adoption of a dry crushing method using a turbo mill, jet mill, or freeze crusher is preferable, and the use of a freeze crusher is more preferable.

There are no specific limitations on the shape of the polyester resin particles to be crushed, but polyester resin produced by a technique used in common production processes is in the form of pellets.

Inorganic particles are added to the polyester resin powder material. There are no specific limitations on the method to be used to produce a uniform resin powder material mixture, and a generally known method may be used to mix the resin powder material and inorganic particles. In an adoptable method, the inorganic particles may be added when performing the aforementioned crushing to allow the crushing and mixing to be carried out simultaneously.

Useful methods for the mixing include mixing by shaking, simultaneous mixing and crushing in a ball mill, coffee mill or the like, mixing by a device with a stirring blade such as Nauta mixer, Henschel mixer, and kneader, mixing by a rotating container type device such as V-shape rotating mixer, liquid phase mixing in a solvent followed by drying, mixing by stirring in an air flow in a flash blender, mixing by spraying powder material and/or slurry using an atomizer or the like, and mixing by using a twin screw extruder.

### Polyester Resin Powder Mixture

A polyester resin powder mixture prepared by adding inorganic particles, preferably together with an inorganic reinforcement material, to a polyester resin powder material has the features of high powder flowability and low compressibility. More specifically, the angle of repose is 40° or less, more preferably 38° or less, and still more preferably 35° or less. Furthermore, it is possible to produce a polyester resin powder mixture having a compressibility of 7.5 or less, more preferably 6.5 or less, and still more preferably 5.5 or less.

The angle of repose and the compressibility are determined based on the Carr's flowability index measuring method (“Terminology Dictionary of Powder Technology—2nd Edition”, edited by the Society of Powder Technology, Japan, published by Nikkan Kogyo Shimbun, Ltd., Mar. 30, 2000, pp. 56-57).

Such a powder mixture is high in flowability and resistant to compaction under powder pressure and accordingly, it will not easily cause troubles such as clogging during supply to and discharge from silos and blocking during air transport. Furthermore, it is small in mean diameter and accordingly able to easily penetrate into carbon fiber, glass fiber, woven fabric, and porous material, and it is expected that a polyester resin powder mixture containing an inorganic reinforcement material can serve to provide moldings with improved strength.

The polyester resin powder mixture can work suitably in processes such as injection molding and extrusion molding and serve to provide fibers, films, powder paints, carbon fiber composite materials, glass fiber composite materials, resins for impregnation of woven fabrics and porous materials, interlaminar spacers for two-layer films, and binders for powder metallurgy materials.

### EXAMPLES

Our mixtures will now be illustrated with reference to Examples and Comparative examples, but it should be understood that this disclosure is not construed as being limited only thereto. The measuring methods used are as described below.

### Mean Diameter

The mean diameter of the polyester resin powder material was measured with a laser diffraction/scattering type particle size distribution measuring apparatus (MT3300EXII manufactured by Nikkiso Co., Ltd.) using 0.5 mass % aqueous solution of polyoxyethylene cumyl phenyl ether (trade name Nonal 912A, manufactured by Toho Chemical Industry Co., Ltd., hereinafter referred as Nonal 912A) as dispersion medium. Specifically, the microtracking technique was used to determine the total volume of the fine particles based on analysis of scattered laser light to prepare a cumulative data curve in which the total volume accounted for 100%, and then the particle diameter at the 50% point (accumulated from the small diameter end) in the cumulative data curve (median diameter, d50) was taken as the mean diameter of the polyester resin powder material.

The mean diameter of fumed silica was determined by observing a specimen by electron microscopy at a magnification of 100,000 times, randomly selecting 100 particles in the image, measuring their maximum lengths, which were assumed to represent their particle diameters, and calculating the number average value to represent their mean diameter. For other types of silica than fumed silica, the same method as used for the polyester resin powder material was used to determine the mean diameter.

### Maximum Size

The maximum size of inorganic reinforcement material was determined by observing a specimen by electron microscopy at a magnification of 1,000 times, randomly selecting 100 particles in the image, measuring their maximum lengths, and calculating the number average value to represent their maximum size.

### Uniformity Coefficient

To determine the uniformity coefficient of the polyester resin powder mixture, the particle diameter distribution was measured with a laser diffraction/scattering type particle size distribution measuring apparatus (MT3300EXII, manufactured by Nikkiso Co., Ltd.) and the d60/d10 ratio was taken as the uniformity coefficient of the polyester resin powder material. A broader particle size distribution gives a larger uniformity coefficient.

### Angle of Repose

The angle of repose of the polyester resin powder mixture was measured with a powder tester (PT-N, manufactured by Hosokawa Micron Corporation).

### Compressibility

Compressibility of the polyester resin powder mixture was calculated by the equation given below from the loose bulk density and the tight bulk density measured by a powder tester (PT-N, manufactured by Hosokawa Micron Corporation).

Compressibility=(tight bulk density−loose bulk density)/tight bulk density×100

### Tensile Strength

To determine the tensile strength of a molded product of the polyester resin powder mixture, a film with a thickness of 70 to 80 μm was prepared by holding the polyester resin powder mixture at 10 MPa for 5 minutes under a press controlled at 260° C. and a 1 cm×10 cm strip was cut out and subjected to test using a universal tester (Tensilon type universal tester RTG-1250, manufactured by A&D Company, Limited). The test was performed under the measuring conditions of a chuck interval of 50 mm and a tension speed of 50 mm/min, and the average of five measurements taken was calculated to represent the tensile strength.

### Production Example 1

In a production unit having a slurry production tank, a slurry storage tank, an esterification reaction tank, two preliminary polymerization tanks, a final polymerization apparatus, and a pelletizer connected in series, terephthalic acid and 1,4-butanediol were supplied at a ratio of 754 parts by weight to 692 parts by weight to the slurry production tank where they were mixed by stirring to prepare a slurry, which was then transferred to the slurry storage tank maintained at a constant temperature of 50° C. and sent by a pump from the slurry storage tank to the complete mixing tank type esterification reaction tank equipped with a fractionating column (first esterification reaction tank) at a constant rate of 1,446 parts by weight/hour while at the same time, a 10%-concentration solution of tetra-n-butyl titanate (TBT) in 1,4-butanediol was supplied continuously to the esterification reaction tank at a rate of 4 parts by weight/hour ([OHin]=7.72 parts by mole/hour, [THFin]=0 part by mole/hour, [COOH]=4.54 parts by mole/hour). The feed molar ratio (P′) of the 1,4-butanediol to the terephthalic acid supplied to the first esterification reaction tank was 1.7, and the quantity of the TBT added was 56 ppm relative to the total polymer weight on the basis of the Ti atom. THF refers to tetrahydrofuran.

The reaction conditions of the esterification reaction tank included a temperature of 230° C., a constant pressure of 73 kPa, and a residence time of 1.8 hours, and THF and water were distilled out from the top of the fractionating column while 1,4-butanediol was refluxed from the bottom of the fractionating column. In this instance, THF was distilled out at 68 parts by weight/hour from the top of the fractionating column, and the real molar ratio (P) was 1.49 in the esterification reaction tank ([THFout]=0.94 parts by mole/hour and [OHout]=0 part by mole/hour). In this esterification reaction tank, furthermore, an oligomer with a reaction rate of 95% for the dicarboxylic acid component was obtained.

Following this, the oligomer was supplied by a gear pump to the complete mixing tank type first preliminary polymerization tank and subjected to reaction under the conditions of a temperature of 245° C., a constant pressure of 4 kPa, and a residence time of 1 hour to obtain an oligomer with a reaction rate of 99.2% for the dicarboxylic acid component and an intrinsic viscosity of 0.20.

Then, this oligomer was supplied by a gear pump to the complete mixing tank type second preliminary polymerization tank while a 10%-concentration solution of TBT in 1,4-butanediol was added at a rate of 4 parts by weight/hour from a midway point in the pipe to the second preliminary polymerization tank (the quantity of the TBT added was 56 ppm relative to the total polymer weight on the basis of the Ti atom). The second preliminary polymerization tank was maintained at a temperature of 245° C. and a pressure of 3.3 kPa and reaction was performed for a residence time of 1 hour to provide an oligomer with an intrinsic viscosity of 0.30.

This oligomer was supplied to the final polymerization unit (lateral-type biaxial reaction unit) and reaction was performed at a temperature of 240° C., a pressure of 200 Pa, and a residence time of 1.5 hours to produce a polymer. This polymer was discharged by a gear pump out of the system through a die to produce a strand, which was cooled with cooling water and pelletized by a pelletizer to provide polyester-1.

### Example 1

Polyester-1 was subjected to crushing for 120 minutes in a jet mill (100 AFG, manufactured by Hosokawa Micron Corporation) to produce a powder material having a mean diameter of 50 μm and a uniformity coefficient of 2.9. As inorganic particles, spherical silica particles with a mean diameter of 50 nm produced by the sol-gel method and surface-treated with hexamethyl disilazane (X-24-9404, manufactured by Shin-Etsu Chemical Co., Ltd.) were added to this powder material at a ratio of 0.5 g to 100 g and mixed by shaking. The resulting polyester resin powder mixture had an angle of repose of 36° and a compressibility of 5.2%, and the film produced by molding the polyester resin powder mixture had a tensile strength of 13 MPa.

### Example 2

Except for adding 3.0 g of the inorganic particles, the same procedure as in Example 1 was carried out to produce a polyester resin powder mixture. The resulting polyester resin powder mixture had an angle of repose of 31° and a compressibility of 5.3%, and the film had a tensile strength of 13 MPa.

### Example 3

Except that the inorganic particles added were spherical silica particles with a mean diameter of 110 nm produced by the sol-gel method and surface-treated with hexamethyl disilazane (X-24-9163A, manufactured by Shin-Etsu Chemical Co., Ltd.), the same procedure as in Example 1 was carried out to produce a polyester resin powder mixture. The resulting polyester resin powder mixture had an angle of repose of 38° and a compressibility of 5.5%, and the film had a tensile strength of 13 MPa.

### Comparative Example 1

Except for not adding inorganic particles, the same procedure as in Example 1 was carried out to produce a polyester resin powder mixture. The resulting polyester resin powder mixture had an angle of repose of 45° and a compressibility of 17.1%, and the film had a tensile strength of 13 MPa.

### Comparative Example 2

Except for adding 10.0 g of the inorganic particles, the same procedure as in Example 1 was carried out to produce a polyester resin powder mixture. The resulting polyester resin powder mixture had an angle of repose of 33° and a compressibility of 9.0%, and the film had a tensile strength of 13 MPa.

### Comparative Example 3

Except that the inorganic particles added were fumed silica particles with a mean diameter of 7 nm (AEROSIL380, manufactured by EVONIK), the same procedure as in Example 1 was carried out to produce a polyester resin powder mixture. The resulting polyester resin powder mixture had an angle of repose of 35° and a compressibility of 7.9%, and the film had a tensile strength of 13 MPa.

### Comparative Example 4

Polyester-1 was subjected to crushing for 30 minutes in a jet mill (100 AFG, manufactured by Hosokawa Micron Corporation) to produce a powder material having a mean diameter of 90 μm and a uniformity coefficient of 5.7. As inorganic particles, spherical silica particles with a mean diameter of 50 nm produced by the sol-gel method and surface-treated with hexamethyl disilazane (X-24-9404, manufactured by Shin-Etsu Chemical Co., Ltd.) were added to this powder material at a ratio of 0.5 g to 100 g and mixed by shaking. The resulting polyester resin powder mixture had an angle of repose of 40° and a compressibility of 7.9%, and the film had a tensile strength of 13 MPa.

### Example 4

Polyester-1 was subjected to crushing for 120 minutes in a jet mill (100 AFG, manufactured by Hosokawa Micron Corporation) to produce a powder material having a mean diameter of 50 μm and a uniformity coefficient of 2.9. As inorganic particles, spherical silica particles with a mean diameter of 50 nm produced by the sol-gel method and surface-treated with hexamethyl disilazane (X-24-9404, manufactured by Shin-Etsu Chemical Co., Ltd.) and, as inorganic reinforcement material, glass beads with a maximum size of 30 μm (EGB731B, manufactured by Potters-Ballotini Co., Ltd.) were added to this powder material at a ratio of 0.5 g and 30 g to 70 g and mixed by shaking. The resulting polyester resin powder mixture had an angle of repose of 37° and a compressibility of 4.9%, and the film had a tensile strength of 15 MPa.

### Example 5

Except for adding 70 g of the inorganic reinforcement material, the same procedure as in Example 4 was carried out to produce a polyester resin powder mixture. The resulting polyester resin powder mixture had an angle of repose of 32° and a compressibility of 4.3%, and the film had a tensile strength of 19 MPa.

### Example 6

Except that the inorganic reinforcement material added was glass flakes with a maximum size of 50 μm (REF-015 A, manufactured by Nippon Sheet Glass Company, Ltd.), the same procedure as in Example 4 was carried out to produce a polyester resin powder mixture. The resulting polyester resin powder mixture had an angle of repose of 36° and a compressibility of 5.1%, and the film had a tensile strength of 21 MPa.

### Example 7

Except that the inorganic reinforcement material added was glass fiber with a maximum size of 120 μm (EPG70M-01N, manufactured by Nippon Electric Glass Co., Ltd.), the same procedure as in Example 4 was carried out to produce a polyester resin powder mixture. The resulting polyester resin powder mixture had an angle of repose of 40° and a compressibility of 6.1%, and the film had a tensile strength of 19 MPa.

### Example 8

Except that the inorganic reinforcement material added was carbon fiber with a maximum size of 180 μm (Panex35, manufactured by Zoltek), the same procedure as in Example 4 was carried out to produce a polyester resin powder mixture. The resulting polyester resin powder mixture had an angle of repose of 34° and a compressibility of 6.1%, and the film had a tensile strength of 22 MPa.

TABLE 1

| | | | Inorganic | | Inorganic reinforcement | | | Characteristics of | | Characteristics |
|---|---|---|---|---|---|---|---|---|---|---|
| | Polyester resin | | particles | | material | | | powder mixture | | of moldings |
| | mean | | mean | | | | maximum | angle of | | tensile |
| | diameter | uniformity | diameter | content | | content | size | repose | compressibility | strength |
| | (μm) | coefficient | (nm) | (wt %) | type | (wt %) | (μm) | (°) | (%) | (MPa) |
| Example 1 | 50 | 2.9 | 50 | 0.5 | — | — | — | 36 | 5.2 | 13 |
| Example 2 | 50 | 2.9 | 50 | 3.0 | — | — | — | 31 | 5.3 | 13 |
| Example 3 | 50 | 2.9 | 110 | 0.5 | — | — | — | 38 | 5.5 | 13 |
| Example 4 | 50 | 2.9 | 50 | 0.5 | glass beads | 30 | 30 | 37 | 4.9 | 15 |
| Example 5 | 50 | 2.9 | 50 | 0.5 | glass beads | 50 | 30 | 32 | 4.3 | 19 |
| Example 6 | 50 | 2.9 | 50 | 0.5 | glass flakes | 30 | 50 | 36 | 5.1 | 21 |
| Example 7 | 50 | 2.9 | 50 | 0.5 | glass fiber | 30 | 120 | 40 | 6.1 | 19 |
| Example 8 | 50 | 2.9 | 50 | 0.5 | carbon fiber | 30 | 180 | 34 | 6.1 | 19 |
| Comparative | 50 | 2.9 | — | — | — | — | — | 45 | 17.1 | 22 |
| example 1 | | | | | | | | | | |
| Comparative | 50 | 2.9 | 50 | 10 | — | — | — | 33 | 9.0 | 13 |
| example 2 | | | | | | | | | | |
| Comparative | 50 | 2.9 | 7 | 0.5 | — | — | — | 35 | 7.9 | 13 |
| example 3 | | | | | | | | | | |
| Comparative | 90 | 5.7 | 50 | 0.5 | — | — | — | 40 | 7.9 | 13 |
| example 4 | | | | | | | | | | |

### INDUSTRIAL APPLICABILITY

The polyester resin powder mixture has high handleability attributed to high powder flowability and, accordingly, it can serve suitably as material for injection molding and extrusion molding. Furthermore, the polyester resin powder mixture contains particles with very small diameters and has high powder flowability and, accordingly, it can be used suitably as it realizes high surface smoothness when used as base particles of powdery paints and shows high impregnating ability when used as matrix resin of carbon fiber reinforced plastics. In addition, high-strength molded products can be obtained when the polyester resin powder mixture is processed by injection molding or extrusion molding or when used as matrix resin for impregnation of carbon fiber or glass fiber.

1.-5. (canceled)

6. A polyester resin powder mixture comprising a polyester resin powder material having a mean diameter of more than 1 μm and 100 μm or less and a uniformity coefficient of 4 or less and accounting for 100 parts by weight and inorganic particles having a mean diameter of 20 to 500 nm and accounting for 0.1 to 5 parts by weight.

7. The polyester resin powder mixture as set forth in claim 6, wherein the polyester is polybutylene terephthalate.

8. The polyester resin powder mixture as set forth in claim 6, wherein the inorganic particles are silica particles.

9. The polyester resin powder mixture as set forth in claim 6 further comprising an inorganic reinforcement material having an average maximum size of 1 μm or more and 200 μm or less and accounting for 25 to 150 parts by weight relative to 100 parts by weight of the polyester resin powder material.

10. The polyester resin powder mixture as set forth in claim 9, wherein the inorganic reinforcement material is at least one selected from the group consisting of glass beads, glass flakes, glass fiber, carbon fiber, aluminum oxide, soda lime glass, borosilicate glass, silica, aluminosilicate ceramics, limestone, gypsum, bentonite, precipitated sodium silicate, amorphous precipitated silica, amorphous precipitated calcium silicate, amorphous precipitated magnesium silicate, amorphous precipitated lithium silicate, sodium chloride, Portland cement, magnesium phosphate cement, magnesium oxychloride cement, magnesium oxysulfate cement, zinc phosphate cement, and zinc oxide.
